(19) United States
(12) Patent Application Publication
(10) Pub. No.: US 2026/0111759 A1
(43) Pub. Date: Apr. 23, 2026

(54) KNOWLEDGE CAPTURE FOR ARTIFICIAL INTELLIGENCE-ASSISTED DECISION-MAKING SYSTEMS

(71) Applicant: GM GLOBAL TECHNOLOGY OPERATIONS LLC, DETROIT, MI (US)

(72) Inventors: Armando Antonio Beltran Pacheco, Rochester Hills, MI (US); Arun Adiththan, Sterling Heights, MI (US); Azeem Sarwar, Rochester Hills, MI (US); Zulfiqar Haider Zaidi, Atlanta, GA (US)

(21) Appl. No.: 18/918,675

(22) Filed: Oct. 17, 2024

(51) Int. Cl. G06N 5/022

(52) U.S. Cl. CPC G06N 5/022

(57) ABSTRACT

Examples described herein provide a method for capturing and representing implicit knowledge to enhance artificial intelligence (AI)-assisted decision-making. The method includes capturing raw data from user interactions and extracting, from the raw data, implicit knowledge representations. The method further includes generating documented implicit knowledge by systematically documenting the implicit knowledge representations, including individual actions and decisions taken during specific tasks, in a knowledge management system. The method further includes categorizing the documented implicit knowledge to create structured knowledge representations. The method further includes integrating the structured knowledge representations into an AI system, wherein the AI system utilizes the implicit knowledge to improve quality of data inputs and enhance decision-making capabilities. The method further includes providing a personalized knowledge management system that allows individuals to document their decision-making processes.

### BACKGROUND

The subject disclosure relates to artificial intelligence-based computing systems, and in particular to knowledge capture for artificial intelligence (AI)-assisted decision-making systems.

Decision-making is the process of choosing the best course of action from various options to achieve specific goals. In industrial settings (e.g., auto manufacturing, aerospace manufacturing, and/or the like), decision-making is important because decisions directly impact efficiency, performance, and overall success. Effective decision-making ensures resources are used optimally, processes run smoothly, and potential problems are addressed proactively or avoided altogether. This is useful for maintaining operational stability, meeting production goals, and staying competitive in a dynamic market. Sound decision-making supports long-term growth and sustainability, making it a cornerstone of successful industrial management.

Expert knowledge in decision-making processes within industrial environments, such as automotive or aerospace manufacturing, involves leveraging specialized understanding of complex systems, production workflows, and industry-specific challenges to optimize operations. This expertise often includes a deep familiarity with manufacturing technologies, supply chain logistics, product designs, and quality control standards. Experts use this knowledge to analyze data, identify potential risks, and implement strategies that enhance efficiency, reduce costs, and maintain high safety and quality standards. Additionally, experts often integrate advanced tools like predictive analytics, artificial intelligence, and automation to support real-time decision-making, ensuring the continuous improvement of production processes in a highly competitive and regulated environment. It may be desirable to non-intrusively capture and document implicit knowledge in decision-making, thereby enhancing the quality of data used in AI-assisted decision-making systems.

### SUMMARY

In one embodiment, a method for capturing and representing implicit knowledge to enhance artificial intelligence (AI)-assisted decision-making is provided. The method includes capturing raw data from user interactions and extracting, from the raw data, implicit knowledge representations. The method further includes generating documented implicit knowledge by systematically documenting the implicit knowledge representations, including individual actions and decisions taken during specific tasks, in a knowledge management system. The method further includes categorizing the documented implicit knowledge to create structured knowledge representations. The method further includes integrating the structured knowledge representations into an AI system, wherein the AI system utilizes the implicit knowledge to improve quality of data inputs and enhance decision-making capabilities. The method further includes providing a personalized knowledge management system that allows individuals to document their decision-making processes.

In addition to one or more of the features described herein, or as an alternative, further embodiments of the method may include that the user interactions comprise typing, talking, keyboard flows, click/touch events, and video.

In addition to one or more of the features described herein, or as an alternative, further embodiments of the method may include that extracting the implicit knowledge representations is performed by applying an attentional span management technique to register the decision-making processes in goal-oriented problem-solving tasks.

In addition to one or more of the features described herein, or as an alternative, further embodiments of the method may include that the attentional span management technique is a scatterfocus template.

In addition to one or more of the features described herein, or as an alternative, further embodiments of the method may include that the AI system receives user inputs and generates agent responses to the user inputs based at least in part on the implicit knowledge representations.

In addition to one or more of the features described herein, or as an alternative, further embodiments of the method may include that the AI system utilizes a large language model.

In addition to one or more of the features described herein, or as an alternative, further embodiments of the method may include that capturing the raw data from the user interactions is performed without altering user behavior or adding extra tasks for a user.

In addition to one or more of the features described herein, or as an alternative, further embodiments of the method may include that capturing the raw data from the user interactions is performed using a manual capture process to deliberately capture the raw data.

In addition to one or more of the features described herein, or as an alternative, further embodiments of the method may include that capturing the raw data from the user interactions is performed using an automatic capture process to deductively capture the raw data.

In another embodiment, a processing system is provided. The processing system includes a memory having computer readable instructions and a processing device for executing the computer readable instructions. The computer readable instructions control the processing system to perform operations for capturing and representing implicit knowledge to enhance artificial intelligence (AI)-assisted decision-making. The instructions include capturing raw data from user interactions, wherein capturing the raw data from the user interactions is performed without altering user behavior or adding extra tasks for a user. The instructions further include extracting, from the raw data, implicit knowledge representations. The instructions further include generating documented implicit knowledge by systematically documenting the implicit knowledge representations, including individual actions and decisions taken during specific tasks, in a knowledge management system. The instructions further include categorizing the documented implicit knowledge to create structured knowledge representations. The instructions further include integrating the structured knowledge representations into an AI system, wherein the AI system utilizes the implicit knowledge to improve quality of data inputs and enhance decision-making capabilities. The instructions further include providing a personalized knowledge management system that allows individuals to document their decision-making processes.

In addition to one or more of the features described herein, or as an alternative, further embodiments of the processing system may include that the user interactions comprise typing, talking, keyboard flows, click/touch events, and video.

In addition to one or more of the features described herein, or as an alternative, further embodiments of the processing system may include that extracting the implicit knowledge representations is performed by applying an attentional span management technique to register the decision-making processes in goal-oriented problem-solving tasks.

In addition to one or more of the features described herein, or as an alternative, further embodiments of the processing system may include that the attentional span management technique is a scatterfocus template.

In addition to one or more of the features described herein, or as an alternative, further embodiments of the processing system may include that the AI system receives user inputs and generates agent responses to the user inputs based at least in part on the implicit knowledge representations.

In addition to one or more of the features described herein, or as an alternative, further embodiments of the processing system may include that the AI system utilizes a large language model.

In another embodiment a computer program product is provided. The computer program product includes a computer readable storage medium having program instructions embodied therewith, the program instructions executable by at least one processor to cause the at least one processor to perform operations for capturing and representing implicit knowledge to enhance artificial intelligence (AI)-assisted decision-making. The operations include capturing raw data from user interactions, wherein capturing the raw data from the user interactions is performed without altering user behavior or adding extra tasks for a user. The operations further include extracting, from the raw data, implicit knowledge representations. The operations further include generating documented implicit knowledge by systematically documenting the implicit knowledge representations, including individual actions and decisions taken during specific tasks, in a knowledge management system. The operations further include categorizing the documented implicit knowledge to create structured knowledge representations. The operations further include integrating the structured knowledge representations into an AI system, wherein the AI system utilizes the implicit knowledge to improve quality of data inputs and enhance decision-making capabilities. The operations further include providing a personalized knowledge management system that allows individuals to document their decision-making processes.

In addition to one or more of the features described herein, or as an alternative, further embodiments of the computer program product may include that the user interactions comprise typing, talking, keyboard flows, click/touch events, and video.

In addition to one or more of the features described herein, or as an alternative, further embodiments of the computer program product may include that extracting the implicit knowledge representations is performed by applying an attentional span management technique to register the decision-making processes in goal-oriented problem-solving tasks.

In addition to one or more of the features described herein, or as an alternative, further embodiments of the computer program product may include that the attentional span management technique is a scatterfocus template.

In addition to one or more of the features described herein, or as an alternative, further embodiments of the computer program product may include that the AI system receives user inputs and generates agent responses to the user inputs based at least in part on the implicit knowledge representations, wherein the AI system utilizes a large language model.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a block diagram of a system for knowledge capture for artificial intelligence (AI)-assisted decision-making systems according to one or more embodiments;

FIG. 2 illustrates a flow diagram of a method for capturing, processing, and utilizing implicit knowledge according to one or more embodiments;

FIG. 3 illustrates a method for utilizing implicit knowledge to enhance AI-assisted decision-making according to one or more embodiments;

FIG. 4 illustrates a system for capturing, processing, and utilizing implicit knowledge according to one or more embodiments;

FIG. 5 illustrates a flow diagram of a method for capturing and representing implicit knowledge to enhance AI-assisted decision-making according to one or more embodiments; and

FIG. 6 illustrates a block diagram of a system for knowledge capture for AI-assisted decision-making systems according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to knowledge capture for artificial intelligence (AI)-assisted decision-making systems.

Technological systems often face challenges related to the quality of data input, commonly referred to as the “garbage in, garbage out” problem. This issue arises when the data fed into these systems lacks the necessary depth and context, leading to suboptimal performance and unreliable outputs. Existing approaches to decision-making systems primarily focus on explicit knowledge, which includes easily documented information, such as facts and instructions. However, these approaches often overlook implicit knowledge (e.g., knowledge of a skilled person or expert), which encompasses the nuanced understanding and experience gained through real-life interactions and problem-solving.

Implicit knowledge, also known as intangible “know-how,” plays a role in decision-making processes, particularly in goal-oriented problem-solving tasks. Implicit knowledge is the knowledge or understanding gained through real-life experience. For example, implicit knowledge is the “know how” that explains the procedure used to complete a task, which thrives on context and experience. Traditional approaches to capturing this type of knowledge are either intrusive or fail to systematically document the decision-making process. As a result, systems lack the comprehensive data for generating accurate and contextually relevant responses. There is a need for an approach that can non-intrusively capture and document implicit knowledge, thereby enhancing the quality of data used in artificial intelligence-assisted decision-making systems.

One or more embodiments described herein provide a systematic and non-intrusive approach to capturing and documenting implicit knowledge from user interactions during specific tasks. Embodiments address the “garbage in, garbage out” problem in AI conversational agents by ensuring high-quality data input. According to an embodiment, a systematic approach is provided to capture information from various interactions such as typing, talking, keyboard flows, click/touch events, and video. One or more embodiments provide for extracting and categorizing knowledge from the captured information, focusing on individual actions and decisions taken during problem-solving processes. One or more embodiments implement attentional span management techniques to register the decision-making process in goal-oriented problem-solving. The creation of value from information produced behind the scenes can be used to enhance the quality of data used in AI systems, like large language models (LLMs). According to one or more embodiments, a personalized knowledge management (PKM) system allows individuals to document their problem-solving approaches and share collaborative knowledge, going beyond traditional note taking or guideline generation. These features individually and collectively provide an effective and efficient way to capture implicit knowledge, which is useful for improving the performance and reliability of AI systems. One or more embodiments provide an approach to capturing implicit knowledge from an engineer's actions during specific tasks without altering the behavior of the engineer, systematically documenting problem-solving methods for AI systems.

Goal-oriented problem-solving involves a decision-making process (“why”) that determines tasks to perform for accomplishing a goal (“what”) based on explicit knowledge and implicit knowledge (“how”). Knowledge differs from information. Information can be seen as data that has been organized or processed in a way that adds context or meaning. Information includes raw facts and figures, for example, that have been structured but not yet interpreted or fully understood. Knowledge goes a step beyond information in that knowledge encompasses the understanding, interpretation, and application of information. Knowledge is information that has been processed by a human mind through learning, experience, and/or instruction. For example, when data is received, it can be processed to generate information. The processing can take documentation templates and formats and apply the data to them to generate design requirements, guidelines, and/or standards, for example, which is the generated information. The information can then be used by a human user using the human user's experience and intuition to derive knowledge from the information. The knowledge is acquired through learning and can be shared with others.

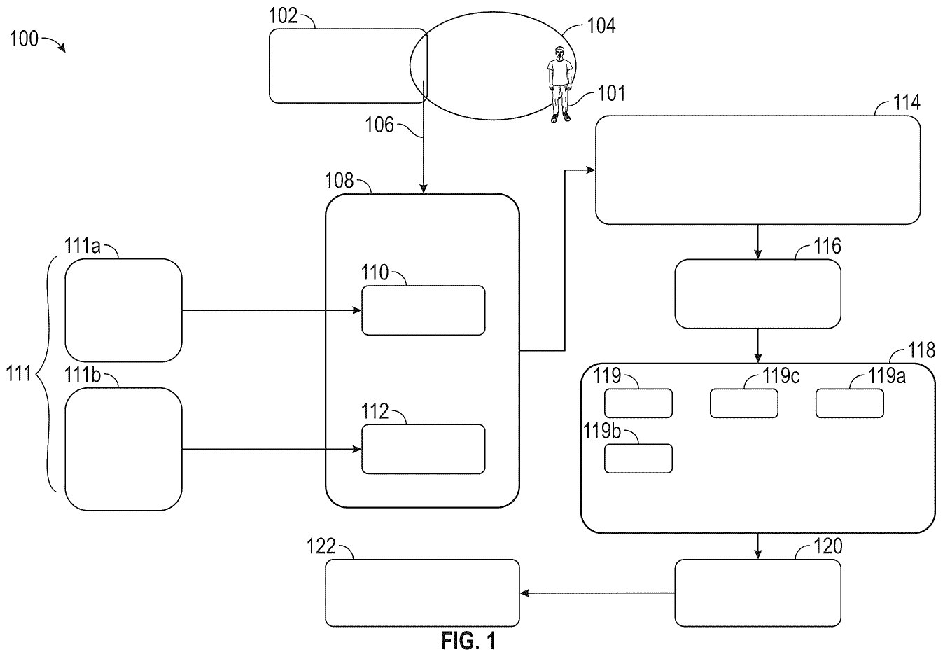

FIG. 1 illustrates a block diagram of a system 100 for knowledge capture for artificial intelligence (AI)-assisted decision-making systems according to one or more embodiments. The system 100, also referred to as an implicit knowledge capturing (IKC) system, facilitates knowledge capture to aid with converting data to information to knowledge to insight. The IKC system allows individuals to document their problem-solving techniques and share consented collaborative knowledge. This approach goes beyond note-taking or guideline generation and instead systematically promotes the documentation of implicit knowledge (“know-how”) and extracts valuable insights from daily work, enhancing the quality of data used in AI systems, such as LLMs.

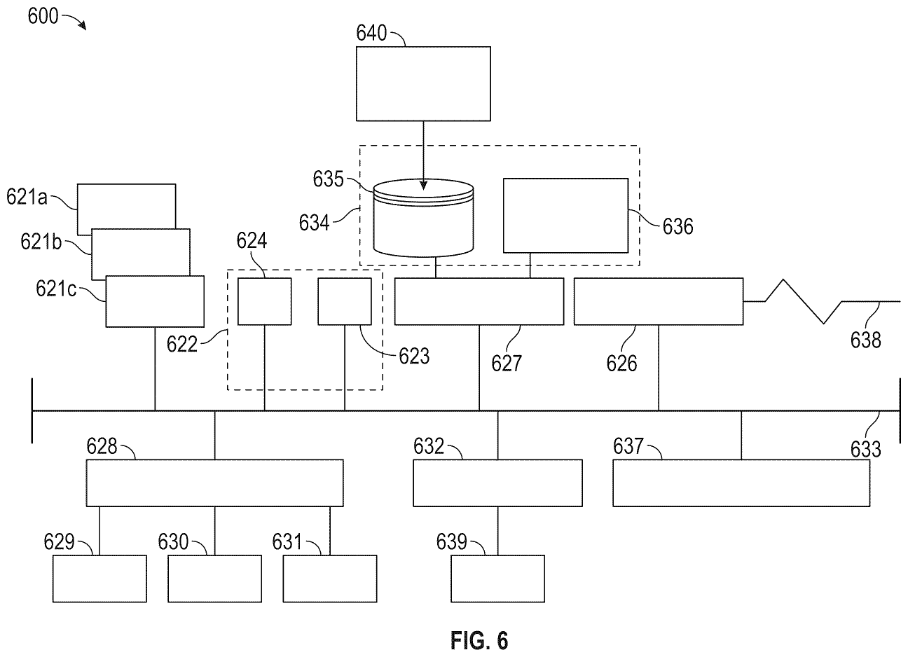

The processing system 102 serves as the central unit for capturing and processing implicit knowledge. The processing system 102 interfaces with various input devices to capture implicit knowledge 104 by collecting raw data 111 from user interactions, such as typing, talking, keyboard flows, click/touch events, and video. The processing system 102 processes this raw data 111 to extract implicit knowledge representations (e.g., captured implicit knowledge 116) using an implicit knowledge registering module 108. The processing system 102 also interacts with other components such as the implicit knowledge base 118 and the knowledge management system 122 to systematically document and categorize the extracted knowledge. According to one or more embodiments, the processing system 102 includes a memory having computer readable instructions and a processing device for executing the computer readable instructions. The computer readable instructions control the processing system to perform operations for capturing and processing implicit knowledge in the AI-assisted decision-making system. The processing system 102 may be implemented using some or all of the components of the processing system 600 of FIG. 6.

The implicit knowledge 104 refers to the nuanced understanding and experience gained through real-life interactions and problem-solving. The implicit knowledge 104 is captured from user interactions obtained during a goal-oriented interaction 106 and processed to generate implicit knowledge representations (e.g., the captured implicit knowledge 116). These representations are then documented and categorized to create structured knowledge that can be utilized by AI systems (e.g., LLM agent 120) to enhance decision-making capabilities of a knowledge management system 122.

The goal-oriented interaction 106 involves capturing user interactions of a subject matter expert 101 that are aimed at achieving a particular goal. These interactions include the actions and decisions taken by the user during problem-solving tasks. The goal-oriented interaction 106 is for understanding the context and rationale behind the decisions of the subject matter expert 101, which is for generating accurate and contextually relevant implicit knowledge representations.

The subject matter expert 101 is the user whose interactions and decision-making processes are being captured and documented. The subject matter expert 101 provides the implicit knowledge 104 that is extracted from the raw data 111 and used to enhance the quality of data inputs for AI systems. The subject matter expert 101 interacts with the processing system 102 and other components to generate insights for AI-assisted decision-making.

The implicit knowledge registering module 108 component is responsible for systematically documenting the implicit knowledge representations extracted from the raw data 111. This component ensures that the captured knowledge is organized and stored in a structured format, making the captured knowledge accessible and usable for AI systems. The implicit knowledge registering module 108 includes a manual capture 110 and an automated capture 112.

The manual capture 110 component allows users, such as the subject matter expert 101, to deliberately document their problem-solving methods and decision-making processes by capturing raw data 111a. The raw data 111a can include typing or talking, for example. The manual capture 110 provides a way for users to manually input their actions and decisions, which are then processed and documented as implicit knowledge. The manual capture 110 is useful for capturing knowledge that may not be easily recorded through automated means.

The automated capture 112 component deductively captures user interactions (e.g., interactions of the subject matter expert 101) without requiring any additional effort from the subject matter expert 101. This component records raw data 111b, which may be actions, typing, talking, keyboard flows, click/touch events, and video, and processes this raw data 111b to extract implicit knowledge representations (e.g., the captured implicit knowledge 116). The automated capture 112 ensures that the knowledge capture process is non-intrusive and does not alter the behavior of the subject matter expert 101.

Once the raw data 111 is captured, it is used to generate the captured implicit knowledge 116 by the implicit knowledge processing 114. This is performed, for example, by applying an attentional span management technique to register decision-making processes in goal-oriented problem-solving tasks. An example of an attentional span management technique is a scatterfocus template, which can be problem solving-focused (e.g., focused on a specific problem) or habitual-based (e.g., focused on habitual tasks). The scatterfocus template is a technique used to manage attentional span and categorize user interactions. The scatterfocus template helps in registering the decision-making process in goal-oriented problem-solving tasks. This template categorizes interactions into specific problem-solving modes, such as habitual mode for routine tasks and problem-solving mode for specific problems. The scatterfocus template aids in systematically documenting the implicit knowledge generated during these interactions.

A non-limiting example of a template (e.g., scatterfocus template) for implicit knowledge representation as part of an implicit knowledge systemic capturing flow is now described. The non-limiting example of the scatterfocus used in the implicit knowledge processing 114 template for implicit knowledge representation is as follows:
# What—Ask what is the end goal
# Goal # Problem # Task—Define a specific problem to solve or task to complete
# Solution—List the possible solutions you can investigate or implement to accomplish the end goal
# Decision—Decide which solution to approach first
# Why—Think of the rationale behind the decision
# How—Register the thinking process while the solution is performed
#Metadata # When # Where—Register any useful metadata like date and time

The captured implicit knowledge 116 refers to the knowledge representations that have been extracted from the raw data 111 and documented in a structured format using the scatterfocus template of the implicit knowledge processing 114. This captured implicit knowledge 116 is stored in the implicit knowledge base 118 and is used to enhance the quality of data inputs for AI systems (e.g., the LLM agent 120 and/or the knowledge management system 122). The captured implicit knowledge 116 includes individual actions and decisions taken during specific tasks, providing insights for AI-assisted decision-making.

The implicit knowledge base 118 is a repository that processes and stores the captured implicit knowledge 116. This knowledge base utilizes attentional span management techniques to register decision-making processes and organize the documented knowledge. The implicit knowledge base 118 interacts with the knowledge management system 122 to provide structured knowledge representations that can be accessed and utilized by AI systems. This approach goes beyond traditional note-taking or guideline generation, providing a structured mechanism to capture and document implicit knowledge.

The PKM 119, PKM 1 119a, PKM 2 119b, and PKM 3 119c are PKM systems tailored for individuals, roles, and/or fields. These PKM systems allow users to document their problem-solving methods and share collaborative knowledge. The PKM systems go beyond traditional note-taking or guideline generation by systematically promoting the documentation of implicit knowledge and extracting insights from daily work.

The LLM agent 120 is an AI system that utilizes large language models (LLMs) to access and utilize the structured knowledge representations stored in the implicit knowledge base 118. The LLM agent 120 generates responses to user queries (known as “prompts”) based on the implicit knowledge, enhancing the decision-making capabilities of the AI system. The LLM agent 120 interacts with the knowledge management system 122 to retrieve context and provide accurate and relevant responses.

The knowledge management system 122 is responsible for organizing and storing the documented implicit knowledge. This system categorizes the knowledge to create structured representations that are accessible and usable for AI systems. The knowledge management system 122 interacts with the implicit knowledge base 118 and the LLM agent 120 to provide a comprehensive knowledge management solution that supports AI-assisted decision-making.

The following is a non-limiting example of implicit knowledge captured using an implicit knowledge capturing flow depicted in FIG. 1:
# What Fix LUT utilization for IP Plant # Solution 1.1 Buy a bigger board # Solution 1.2 Use Speedgoat FPGA with SXG # Solution 1.3 Pivot to a even smaller plant model # Solution 1.4 Look for a loaner board # Decison 1.4 # Why I remember i saw Xilnix boards at lab 209 # How I went to 209 lab and check what type of hardware is available, a compatible and more powerful board was available, i contacted Wei Tong, the contact in the sticker. He lent the board, im pivoting to use ZYNQ board for SoCIL PoC
# What connect Zynq to laptop # Solution Play with the board # Why easy thing to do is just to use the other usb port available
# What UART working on pheripherial test # Solution 1.1 check memory map and see if the location of uartlite is ok # Solution 1.2 compare hello world with pher test
# What ADC driver test on Zynq # Why to include it in the CL test
# How Reuse the ADC driver test for Artix 7 board
# What Solve Serial communication isse # Why ADC driver builds, however, serial communication still not working properly # Solution 1.1 Check the memory map
# What Fix Memory map # Why When i try to debug code, there is a memory issue, checking Vivado design and and .xsa file, and memory in XSCT console the code uses 0x3b4f bytes and the memory assigned for microblaze is 0x1fff # Solution 1.1 change the microblaze local memory to 64K # Decision 1.1 Worked to fix the debugging issue, microblaze local memory has to be bigger than what is shown in the download program report
# What Fix serial communication issue # Solution 1.1 function clean up # Solution 1.2 float to string function # Decision 1.2 is the issue, when commented out conversion function and also clean function the raw data works well

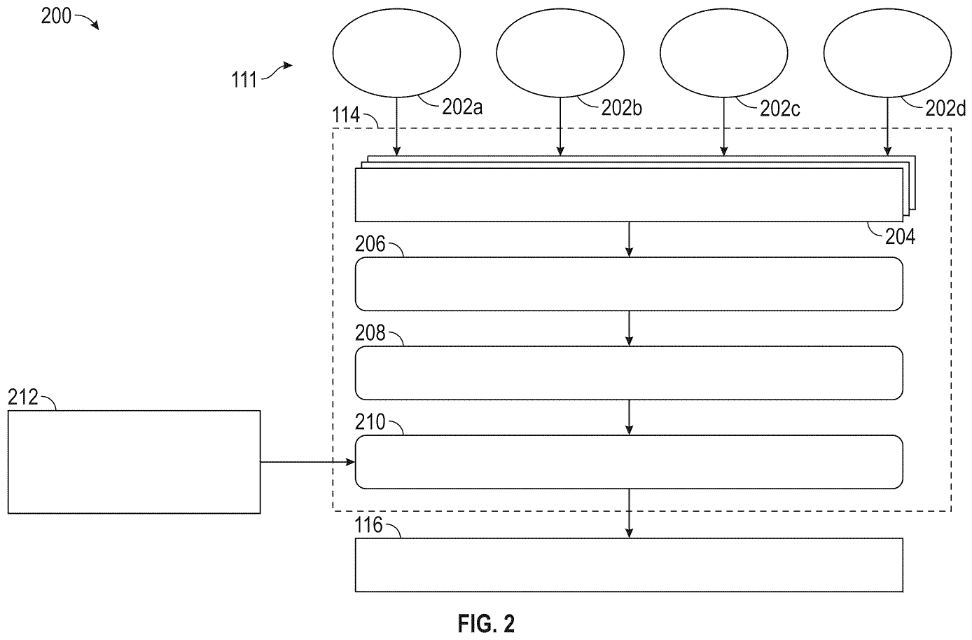

FIG. 2 illustrates a flow diagram of a method 200 for processing, and utilizing implicit knowledge according to one or more embodiments. The raw data 111, such as audio 202a, screen interaction 202b, video 202c, other data 204d, and/or the like, including combinations and/or multiples thereof, are captured as described herein.

The audio 202a captures audio data from user interactions of the subject matter expert 101. For example, spoken words and sounds are recorded during user activities, providing a rich source of information that reflects the user's decision-making process. According to one or more embodiments, the audio 202a is then processed to extract meaningful insights and implicit knowledge representations.

The screen interaction 202b captures user interactions with the screen, including mouse movements, clicks, touch events, and/or the like, including combinations and/or multiples thereof. For example, the user's actions on the screen, such as selecting options, navigating through menus, and interacting with software applications can be monitored and captured. The captured screen interactions provide context for understanding the user's problem-solving approach.

The video 202c captures video data of the user's activities. For example, visual information, such as the user's facial expressions, gestures, interactions with physical objects, and/or the like, including combinations and/or multiples thereof, can be recorded. The video data complements the audio and/or screen interaction data, offering a comprehensive view of the user's behavior and decision-making process.

According to one or more embodiments, other data 202d can be captured as described herein.

The method 200 starts by feeding the raw data 111, once captured, into the implicit knowledge processing 114, which may include one or more multi-modal LLM Instance(s) 204. The multi-modal LLM Instance(s) 204 represents instances of large language models (LLMs) that process the captured raw data. These LLM instances analyze the raw data 111, including audio, screen interactions, and video, to generate transcriptions and extract semantic information. The LLM instances play a role in converting raw data into structured knowledge representations.

At block 206, the method 200 includes processing transcripts generated by the multi-modal LLM instance(s) 204. The processing at block 206 involves processing textual transcriptions from the captured audio and video data. The transcriptions provide a detailed record of the user's interactions and decision-making process. The processing includes identifying key words and phrases.

At block 208, the method 200 includes extracting semantics from the processed transcripts. The extraction at block 208 involves extracting semantic information from the processed transcripts. This can include identifying concepts, actions, and decisions within the transcripts, providing a deeper understanding of the user's problem-solving approach. The extracted semantics form the basis for creating structured knowledge representations.

At block 210, the method 200 includes populating a knowledge template, which involves organizing the extracted semantic information into predefined templates. At this block, the captured implicit knowledge is documented in a structured and consistent format and is output as the captured implicit knowledge 116. The knowledge templates categorize the information based on specific problem-solving tasks, actions, and decisions, for example. According to one or more embodiments, at block 210, previously captured implicit knowledge 212 is used, which represents implicit knowledge that was previously captured, such as using one or more of the embodiments described herein. By using the previous captured implicit knowledge 212, block 210 can generate more accurate implicit knowledge.

The captured implicit knowledge 116 refers to the structured knowledge representations generated from the raw data. This component stores the documented implicit knowledge, making the documented implicit knowledge accessible for AI systems (e.g., the knowledge management system 122) to enhance decision-making capabilities. The captured implicit knowledge 116 includes detailed records of the user's actions, decisions, and problem-solving approaches.

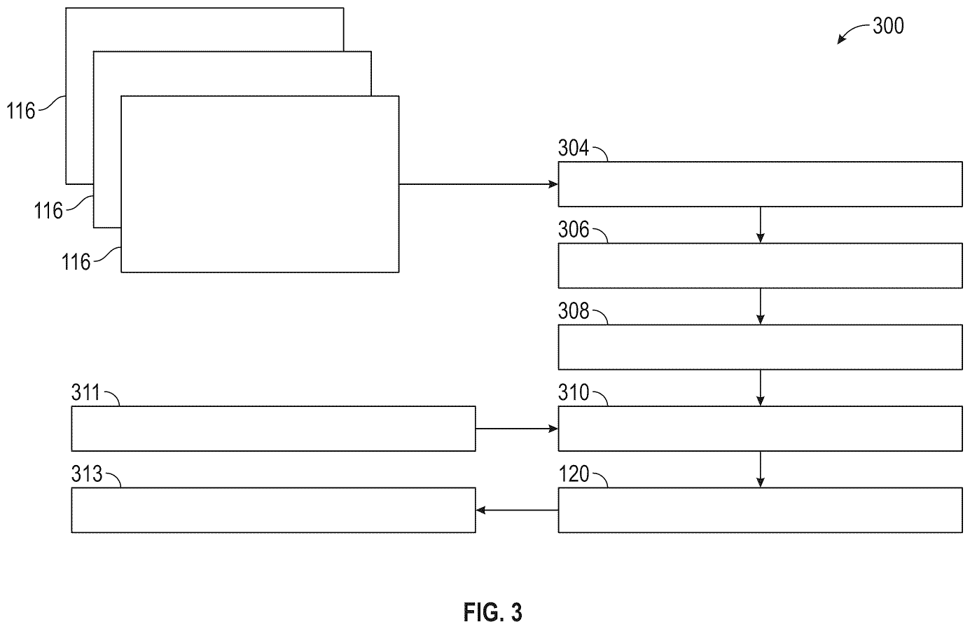

FIG. 3 illustrates a method 300 for utilizing implicit knowledge to enhance AI-assisted decision-making according to one or more embodiments. The method 300 includes several steps designed to process and manage implicit knowledge, ensuring that AI systems can leverage this knowledge for improved decision-making capabilities.

The captured implicit knowledge 116 represents the knowledge extracted from raw data collected during user interactions. This knowledge includes the nuanced understanding and experience gained through real-life problem-solving tasks. The captured implicit knowledge 116 is systematically documented and categorized to create structured knowledge representations that can be utilized by AI systems as described herein.

At block 304, the captured implicit knowledge 116 is loaded to the implicit knowledge base 118 and split based on the individual (person), role (function), field (area), or other category or property. This step ensures that the captured implicit knowledge 116 is documented in a structured and consistent format, making the knowledge easier to manage and retrieve. The scatterfocus templates categorize the captured implicit knowledge 116 based on specific problem-solving tasks, actions, and decisions, facilitating the systematic documentation of implicit knowledge.

At block 306, the captured implicit knowledge 116 is embedded into a format that can be easily accessed and utilized by AI systems. This step ensures that the captured implicit knowledge is organized and stored in a way that allows for efficient retrieval and integration into AI processes. The embedding process may involve converting the knowledge into vectors or other representations suitable for machine learning models.

At block 308, the captured implicit knowledge 116 stores the embeddings. This step ensures that the knowledge is securely stored and can be efficiently retrieved when queried. The captured implicit knowledge 116 may include indexing mechanisms to facilitate quick access to specific knowledge representations based on user queries or AI system requirements.

At block 310, responsive to a user prompt 311 being received, the captured implicit knowledge 116 retrieves context-relevant knowledge representations based on the context of the user prompt 311. The user prompt 311 represents the input provided by a user to the AI system. This prompt may include questions, commands, or other forms of input that cause the AI system to generate a response. For example, the user prompt 311 may pose a question, such as “How do I enable a windows subsystem for linux on windows?” The user prompt 311 serves as the starting point for the AI system to retrieve and utilize the relevant implicit knowledge stored in the knowledge base. Block 310 ensures that the AI system can access the most relevant and contextually appropriate knowledge to generate accurate and useful responses. The retrieval process may involve searching the knowledge base using keywords, semantic matching, or other techniques to identify the most relevant knowledge representations.

The LLM agent 120 represents an AI system that utilizes large language models (LLMs) to process the user prompt and generate a response using the retrieved context from block 310 based on the captured implicit knowledge 116. The LLM agent 120 leverages the structured knowledge representations stored in the knowledge base to enhance the decision-making capabilities of the LLM agent 120. By accessing the implicit knowledge, the LLM agent 120 can provide more accurate, contextually relevant, and insightful responses to user queries.

The agent response 313 represents the output generated by the LLM agent 120 in response to the user prompt 311. This response is based on the captured implicit knowledge 116 retrieved from the implicit knowledge base 118 and processed by the LLM agent 120. The agent response 313 provides the user with the information, guidance, or decision support needed to address the query or task at hand. For example, for the user prompt 311 regarding enabling a windows subsystem for linux on windows (e.g., a goal), the agent response 313 may describe one or more steps/tasks for the user to take to achieve the goal.

According to one or more embodiments, the user prompt 311 and the agent response 313 may be iterative in that a user can input a prompt, receive a response, and then input a new or revised prompt in response to the response. In this way, the LLM agent 120 can provide improved agent responses, such as providing additional or alternative steps/tasks to achieve the goal.

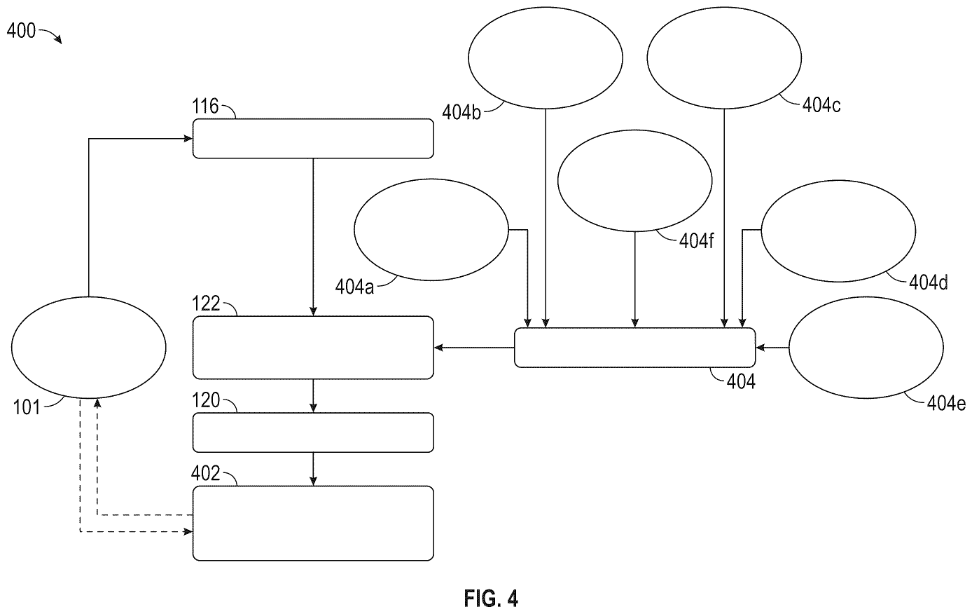

FIG. 4 illustrates a system 400 for capturing, processing, and utilizing implicit knowledge according to one or more embodiments.

The subject matter expert 101 interacts with the system 400 to provide implicit knowledge through various user interactions. The actions and decisions of the subject matter expert 101 during specific tasks are captured and documented to generate the captured implicit knowledge 116 as described herein. These interactions may include, for example, typing, talking, keyboard flows, click/touch events, and video, which are processed to extract meaningful insights. The subject matter expert 101 plays a role in enhancing the quality of data inputs for AI systems by providing nuanced understanding and experience gained through real-life problem-solving.

The captured implicit knowledge 116 refers to the knowledge representations extracted from the raw data collected from the subject matter expert 101. This knowledge is systematically documented and categorized to create structured knowledge representations. The captured implicit knowledge 116 includes individual actions and decisions taken during specific tasks, providing insights for AI-assisted decision-making. This knowledge is stored in the implicit knowledge base 118 of FIG. 1 and utilized by AI systems (e.g., the LLM agent 120) to improve decision-making capabilities.

The LLM agent 120 is an AI system that utilizes large language models to access and utilize the structured knowledge representations stored in the knowledge base. The LLM agent 120 generates responses (e.g., agent response 313) to user queries (e.g., user prompt 311) based on the captured implicit knowledge 116, enhancing the decision-making capabilities of the AI system. The LLM agent 120 interacts with the knowledge management system 122 to retrieve context and provide accurate and relevant responses, thereby improving the quality of data inputs and enhancing decision-making processes.

The knowledge management system 122 is responsible for organizing and storing the documented implicit knowledge. This system categorizes the knowledge to create structured representations that are accessible and usable for AI systems. The knowledge management system 122 interacts with the implicit knowledge base 118 of FIG. 1 and the LLM agent 120 to provide a comprehensive knowledge management solution that supports AI-assisted decision-making. The knowledge management system 122 ensures that the captured knowledge is systematically documented and categorized, making the captured knowledge accessible for future use.

Prompting to support decision-making for problem solving involves the input provided by a user to the AI system (e.g., user prompt 311) with the intention to support the user's decision-making process in solving a specific problem, completing a task, or achieving a goal._.

According to one or more embodiments, knowledge systematic authentication is performed by the subject matter expert 101 using prompting to support decision-making for problem solving 402. The systematic authentication is the process by which the answers provided by the AI system are validated by the user confirming the knowledge provided is actually useful in solving a specific problem, completing a task, or achieving a goal.

The knowledge management system 122 can also utilize explicit knowledge 404, which includes easily documented information, such as facts, instructions, and guidelines. The explicit knowledge 404 is stored in various databases and repositories, such as a calibration guidelines database 404a, production code repositories 404b, configuration management tool/procedures 404c, function SharePoint documents 404d, tool guidelines and processes, standards 404e, internal social networks 404f, and/or the like, including combinations and/or multiples thereof. The explicit knowledge 404 is used in conjunction with the captured implicit knowledge 116 to provide a comprehensive knowledge management solution. According to one or more embodiments, the explicit knowledge 404 is organized and stored in a structured format, making the explicit knowledge 404 accessible for AI systems to enhance decision-making capabilities.

The calibration guidelines database 404a stores guidelines and procedures related to calibration processes. The production code repositories 404b store code and scripts related to production processes. The configuration management tool/procedures 404c store tools and procedures related to configuration management. The function SharePoint documents 404d store documents related to specific functions and tasks. The tool guidelines and processes, standards 404e store guidelines, processes, and standards related to various tools and procedures. The internal social networks 404f store information and knowledge shared within internal social networks.

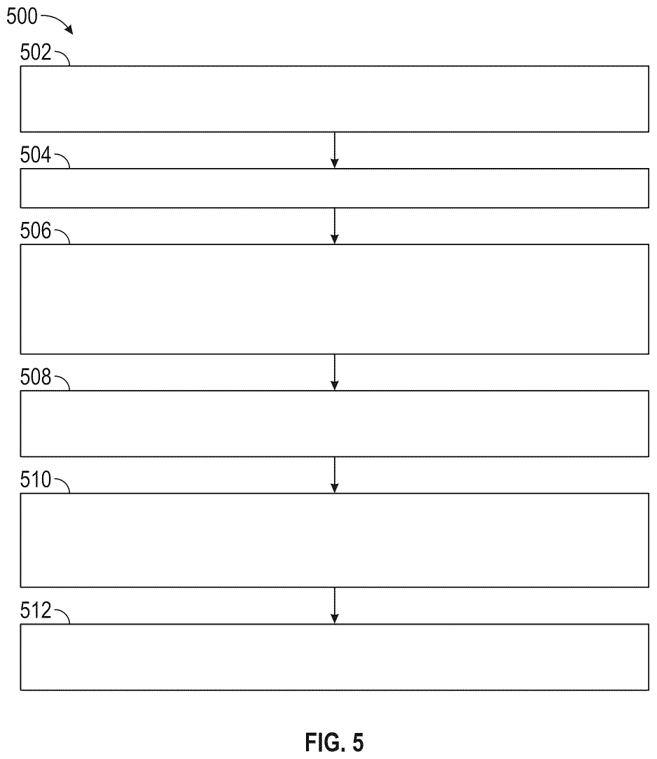

FIG. 5 is a flow diagram of a method 500 for capturing and representing implicit knowledge to enhance AI-assisted decision-making according to one or more embodiments. The method 500 can be implemented using any suitable system or device. For example, the method 500 can be implemented using the processing system 102 of FIG. 1, the processing system 600 of FIG. 6, and/or the like, including combinations and/or multiples thereof. The method 500 is now described with reference to FIGS. 1, 2, 3, and/or 4 but is not so limited.

At block 502, the method 500 includes capturing raw data (e.g., raw data 111) from user interactions without altering user behavior or adding extra tasks for the user (e.g., subject matter expert 101). This step involves capturing raw data from various user interactions, such as typing and/or talking (e.g., raw data 111a) and/or keyboard flows, click/touch events, text, actions, and/or video (e.g., raw data 111b), without requiring the user to change their behavior or perform additional tasks. Thus, this step provides for the non-intrusive nature of the data capture process.

At block 504, the method 500 includes extracting, from the raw data (e.g., the raw data 111), implicit knowledge representations (e.g., captured implicit knowledge 116). In this step, the captured raw data is applied to a scatterfocus template to process the captured raw data to extract implicit knowledge representations. This involves identifying and isolating the knowledge embedded in the user's actions and decisions.

At block 506, the method 500 includes generating documented implicit knowledge by systematically documenting the implicit knowledge representations, including individual actions and decisions taken during specific tasks, in a knowledge management system (e.g., the knowledge management system 122). This step involves systematically documenting the extracted implicit knowledge representations as PKMs (e.g., PKM 119, PKM1 119a, PKM2 119b, PKM3 119c), including the individual actions and decisions taken during specific tasks, in a knowledge management system. The PKMs can be individualized to an individual (person), to a role (function), and/or to a field (area).

At block 508, the method 500 includes categorizing the documented implicit knowledge to create structured knowledge representations. In this step, the documented implicit knowledge is categorized to create structured knowledge representations. This organization helps in making the knowledge more accessible and usable for AI systems.

At block 510, the method 500 includes integrating the structured knowledge representations into an AI system (e.g., the LLM agent 120). The AI system utilizes the implicit knowledge to improve the quality of data inputs and enhance decision-making capabilities. This step involves integrating the structured knowledge representations into an AI system. The AI system utilizes the implicit knowledge to improve the quality of data inputs and enhance its decision-making capabilities. For example, a user can generate user prompts (e.g., user prompt 311) which can be input into the AI system, and the AI system can generate outputs (e.g., agent response 313) based on the implicit knowledge.

At block 512, the method 500 includes providing a personalized knowledge management system (e.g., the knowledge management system 122) that allows individuals to document their decision-making processes.

Additional processes also may be included, and it should be understood that the processes depicted in FIG. 5 represent illustrations, and that other processes may be added, or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processor(s) 621 of FIG. 6) of a computing system (e.g., the processing system 102 of FIGS. 1 and 2, the processing system 600 of FIG. 6, and/or the like, including combinations and/or multiples thereof), cause the processor to perform the processes described herein.

One or more embodiments described herein provide improvements to the functioning of a computer (e.g., a processing system) and the overall process of capturing and utilizing implicit knowledge for AI-assisted decision-making. These improvements enhance the efficiency, accuracy, and usability of the knowledge management system, providing significant benefits over traditional approaches to knowledge management and data capture from subject matter experts. Examples of one or more improvements may include one or more of the following.

Non-Intrusive Data Capture: One or more embodiments employs non-intrusive methods to capture raw data from user interactions without altering user behavior or adding extra tasks. This ensures that the data collection process does not interfere with the user's workflow, leading to more natural and accurate data capture. The processing system can seamlessly record interactions such as typing, talking, keyboard flows, click/touch events, and video, providing a comprehensive dataset for analysis.

Systematic Documentation of Implicit Knowledge: One or more embodiments provides a structured mechanism to systematically document implicit knowledge, which is often unspoken and difficult to articulate. By processing raw data and extracting implicit knowledge representations, the system creates detailed records of individual actions and decisions taken during specific tasks. This systematic documentation enhances the quality and depth of data available for AI systems, improving their decision-making capabilities.

Enhanced Data Processing Capabilities: One or more embodiments provides advanced data processing modules that analyze raw data, extract implicit knowledge, and generate structured knowledge representations. These modules utilize techniques such as attentional span management and scatterfocus templates to identify and document the knowledge embedded in user interactions. The improved data processing capabilities enable the system to handle complex datasets and generate accurate and contextually relevant knowledge representations.

Integration with AI Systems: One or more embodiments integrates the structured knowledge representations into AI systems, such as large language models (LLMs). This integration allows AI systems to utilize the implicit knowledge to improve the quality of data inputs and enhance decision-making capabilities. By accessing both explicit and implicit knowledge sources, AI systems can generate more accurate, relevant, and insightful responses to user queries.

Personalized Knowledge Management: One or more embodiments includes PKM systems tailored for individuals, roles, and domains. These PKM systems allow users to document their problem-solving methods and share collaborative knowledge. The personalized approach ensures that the knowledge management system is relevant and efficient for each user, enhancing the usability and effectiveness of the system.

Enhanced Decision-Making Support: By capturing and utilizing implicit knowledge, one or more embodiments provides enhanced decision-making support for users. One or more embodiments generates detailed records of problem-solving approaches, actions, and decisions, providing valuable insights for future tasks or goals. The AI systems can leverage this knowledge to provide contextually relevant guidance and support, improving the overall decision-making process.

Comprehensive Data Analysis: One or more embodiments processes raw interaction data from various sources, such as audio, keyboard inputs, clicks/touch events, and video, to extract meaningful knowledge representations. This comprehensive data analysis provides a deeper understanding of user interactions and problem-solving approaches, leading to more accurate and effective AI-driven solutions.

Attentional Span Management: One or more embodiments applies attentional span management techniques to categorize and document user interactions. Techniques, such as scatterfocus templates, help manage attentional span and register decision-making processes in goal-oriented problem-solving tasks. This approach ensures that the captured knowledge is organized and documented in a structured format, enhancing its usability for AI systems.

Value Creation from Daily Activities: By systematically extracting and categorizing knowledge from daily work activities, one or more embodiments creates value from routine tasks. The captured implicit knowledge enhances the quality of data used in AI systems, leading to more accurate and effective AI-driven solutions. This value creation from daily activities supports continuous improvement and innovation in various domains.

One or more embodiments provide one or more of these and/or other improvements to the functioning of a computer (processing system) and the overall process of capturing and utilizing implicit knowledge. These improvements enhance the efficiency, accuracy, and usability of the system, providing significant benefits for AI-assisted decision-making and knowledge management.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s)). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing, and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 629 and mouse 630, and output capability including speaker 631 and display 639. In some aspects of the present disclosure, a portion of system memory 622 and mass storage 634 collectively store the operating system 640 to coordinate the functions of the various components shown in processing system 600.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for capturing and representing implicit knowledge to enhance artificial intelligence (AI)-assisted decision-making, the method comprising:
capturing raw data from user interactions;
extracting, from the raw data, implicit knowledge representations;
generating documented implicit knowledge by systematically documenting the implicit knowledge representations, including individual actions and decisions taken during specific tasks, in a knowledge management system;
categorizing the documented implicit knowledge to create structured knowledge representations;
integrating the structured knowledge representations into an AI system, wherein the AI system utilizes the implicit knowledge to improve quality of data inputs and enhance decision-making capabilities; and
providing a personalized knowledge management system that allows individuals to document their decision-making processes.

2. The computer-implemented method of claim 1, wherein the user interactions comprise typing, talking, keyboard flows, click/touch events, and video.

3. The computer-implemented method of claim 1, wherein extracting the implicit knowledge representations is performed by applying an attentional span management technique to register the decision-making processes in goal-oriented problem-solving tasks.

4. The computer-implemented method of claim 3, wherein the attentional span management technique is a scatterfocus template.

5. The computer-implemented method of claim 1, wherein the AI system receives user inputs and generates agent responses to the user inputs based at least in part on the implicit knowledge representations.

6. The computer-implemented method of claim 5, wherein the AI system utilizes a large language model.

7. The computer-implemented method of claim 1, wherein capturing the raw data from the user interactions is performed without altering user behavior or adding extra tasks for a user.

8. The computer-implemented method of claim 1, wherein capturing the raw data from the user interactions is performed using a manual capture process to deliberately capture the raw data.

9. The computer-implemented method of claim 1, wherein capturing the raw data from the user interactions is performed using an automatic capture process to deductively capture the raw data.

10. A processing system comprising:
a memory comprising computer readable instructions; and
a processing device for executing the computer readable instructions, the computer readable instructions controlling the processing system to perform operations for capturing and representing implicit knowledge to enhance artificial intelligence (AI)-assisted decision-making, the operations comprising:
capturing raw data from user interactions, wherein capturing the raw data from the user interactions is performed without altering user behavior or adding extra tasks for a user;
extracting, from the raw data, implicit knowledge representations;
generating documented implicit knowledge by systematically documenting the implicit knowledge representations, including individual actions and decisions taken during specific tasks, in a knowledge management system;
categorizing the documented implicit knowledge to create structured knowledge representations;
integrating the structured knowledge representations into an AI system, wherein the AI system utilizes the implicit knowledge to improve quality of data inputs and enhance decision-making capabilities; and
providing a personalized knowledge management system that allows individuals to document their decision-making processes.

11. The processing system of claim 10, wherein the user interactions comprise typing, talking, keyboard flows, click/touch events, and video.

12. The processing system of claim 10, wherein extracting the implicit knowledge representations is performed by applying an attentional span management technique to register the decision-making processes in goal-oriented problem-solving tasks.

13. The processing system of claim 12, wherein the attentional span management technique is a scatterfocus template.

14. The processing system of claim 10, wherein the AI system receives user inputs and generates agent responses to the user inputs based at least in part on the implicit knowledge representations.

15. The processing system of claim 14, wherein the AI system utilizes a large language model.

16. A computer program product comprising a computer readable storage medium having program instructions embodied therewith, the program instructions executable by at least one processor to cause the at least one processor to perform operations for capturing and representing implicit knowledge to enhance artificial intelligence (AI)-assisted decision-making, the operations comprising:
capturing raw data from user interactions, wherein capturing the raw data from the user interactions is performed without altering user behavior or adding extra tasks for a user;
extracting, from the raw data, implicit knowledge representations;
generating documented implicit knowledge by systematically documenting the implicit knowledge representations, including individual actions and decisions taken during specific tasks, in a knowledge management system;
categorizing the documented implicit knowledge to create structured knowledge representations;
integrating the structured knowledge representations into an AI system, wherein the AI system utilizes the implicit knowledge to improve quality of data inputs and enhance decision-making capabilities; and
providing a personalized knowledge management system that allows individuals to document their decision-making processes.

17. The computer program product of claim 16, wherein the user interactions comprise typing, talking, keyboard flows, click/touch events, and video.

18. The computer program product of claim 16, wherein extracting the implicit knowledge representations is performed by applying an attentional span management technique to register the decision-making processes in goal-oriented problem-solving tasks.

19. The computer program product of claim 18, wherein the attentional span management technique is a scatterfocus template.

20. The computer program product of claim 16, wherein the AI system receives user inputs and generates agent responses to the user inputs based at least in part on the implicit knowledge representations, wherein the AI system utilizes a large language model.
